(19) United States
(12) Patent Application Publication
(10) Pub. No.: US 2003/0020690 A1
(43) Pub. Date: Jan. 30, 2003

(54) Trackball

(76) Inventors: Pai-Li Chen, Taipei Hsien (TW); Ken-Pei Hu, Taipei Hsien (TW)

Correspondence Address: BACON & THOMAS, PLLC, 625 Slaters Lane, 4th Floor, Alexandria, VA, 22314-1176, US

(21) Appl. No.: 09/912,356

(22) Filed: Jul. 26, 2001

(51) Int. Cl. G09G 5/08

(52) U.S. Cl. 345/167

(57) ABSTRACT

A trackball rotatably mounted in a hole of a cursor pointing device comprises a core layer of a first color having an engagement section including a plurality of engagement members on a surface; and an outer layer of a second color filled in a space between the engagement members; wherein a surface of the outer layer is flush with that of the core layer so that a plurality of speckles are formed on the engagement members and the trackball thus has two different colors.

### FIELD OF THE INVENTION

The present invention relates to a trackball, more particularly to the structure of a trackball having two different colors.

### BACKGROUND OF THE INVENTION

A conventional trackball device 1 such as disclosed in U.S. Pat. Nos. 5,288,993 and 5,703,356 is shown in FIG. 1 comprising an upper housing 10 and a lower housing 11 being for example threadedly secured together. Necessary circuitry and electronic components are mounted within trackball 1. One button (or more than one button in other implementations) 12 and a circular opening 14 are formed on upper housing 10. A trackball 20 is fitted in the opening 14 with the upper half portion projected above the surface of upper housing 10 such that user may rotate trackball 20 with hand. An optical device 30 is adjacent trackball 20 within the trackball device 1 for emitting light to trackball 20 and creating an image of an illuminated portion of the trackball 20 from the reflected light thereof so as to process and calculate a direction and distance proportional to the rotation of the trackball 20 as detailed below.

An enlarged and detailed view of trackball 20 and optical device 30 is shown in FIG. 2. Optical device 30 comprises a light source 31 for flooding a portion of trackball 20 with diffuse light and a photodetector 32 for creating image of an illuminated portion of the trackball 20 from the reflected light thereof. Trackball device 1 then processes such fetched images and compares the difference between a previous image and a current one. Further, a direction and distance proportional to the rotation of the trackball 20 is calculated if the difference exists. Hence, a corresponding movement of cursor will be shown on a display screen of for example personal computer which is electrically coupled to trackball device 1. In view of above, the quality of fetched image will be critical to the precision of the calculated direction and distance of a moving cursor.

A number of things are proposed herein for manufacturers and designers to consider. For example, the smoothness of the rotation and the maneuverability of trackball 20 are important factors since trackball device 1 is designed to be rotated by user for moving a cursor on screen. Conventionally, ball is of hard construction (e.g., molded thermoplastic) and has a very smooth surface for facilitating rotational operation by reducing friction and for preventing from being deformed. But this is unsatisfactory for the purpose for which the invention is concerned because an intense diffuse light is reflected (since the surface of trackball 20 is very smooth) after light is flooded onto the trackball 20 from light source 31. As such, the effect of photodetector 32 of creating an image of an illuminated portion of the trackball 20 from the reflected light is compromised while only the intense diffuse light is received. This makes a correct comparison between the previous image and the current one impossible. Thus a correct calculation of direction and distance proportional to the rotation of the trackball 20 is not obtained. Hence, a precise movement of cursor will not be shown on display screen. The prior art shown in FIG. 2 discloses a technique of printing a plurality of uniformly arranged speckles 21 on the surface of trackball 20 for decreasing the reflectivity of diffuse light from trackball 20. As a result, a clear image of an illuminated portion of the trackball 20 may be created by photodetector 32.

However, speckles 21 on trackball 20 thus manufactured may peel off after a relatively long period time of use. As a result, photodetector element 32 may not correctly create an image, thus failing a synchronism between cursor and trackball. Thus, it is desirable to provide an improved trackball and manufacturing method therefor in order to overcome the above drawbacks (i.e., printing equally spaced and uniformly disposed speckles on the surface of the unfinished trackball is high in cost and suffered by many limitations) of prior art.

### SUMMARY OF THE INVENTION

It is therefore an object of the present invention to provide a trackball rotatably mounted in a hole of a cursor pointing device. The trackball comprises a core layer of a first color having an engagement section including a plurality of engagement members on a surface; and an outer layer of a second color filled in a space between the engagement members; wherein a surface of the outer layer is flush with that of the core layer so that a plurality of speckles are formed on the engagement members and the trackball thus has two different colors.

In one aspect of the present invention, each of core layer and outer layer is formed of transparent or semi-transparent resin with reflective speckles (or particles) randomly distributed therein so that as light emitted from light source of an optical device most of the light penetrates into the trackball wherein a portion of the light is reflected back to a surface of the trackball by the speckles or particles prior to further reflecting back. Hence, a photodetector element can continuously sense image reflected from the trackball so as to correctly calculate a distance and direction of a movement of the trackball. Thus a failing of synchronism between cursor and trackball as experienced in prior art is substantially eliminated.

The above and other objects, features and advantages of the present invention will become apparent from the following detailed description taken with the accompanying drawings.

### BRIEF DESCRIPTION OF THE DRAWINGS

FIG. 1 is a perspective view of a conventional trackball;

FIG. 2 is a plan view schematically showing a position of optical device versus trackball shown in FIG. 1;

FIG. 3 is a plan view showing core layer and trackball of a first preferred embodiment according to the invention;

FIG. 4 is a plan view showing core layer and trackball of a second preferred embodiment according to the invention;

FIG. 5 is a plan view showing core layer and trackball of a third preferred embodiment according to the invention;

FIG. 6 is a flow chart diagram of a track ball manufacturing process according to the invention;

FIG. 7 is a cross-sectional view showing a position of optical device versus trackball of the invention;

FIG. 8 is a greatly enlarged cross-sectional view of FIG. 7 showing light impinged on and reflected from trackball of one embodiment; and

FIG. 9 is a greatly enlarged cross-sectional view of FIG. 7 showing light penetrated into and reflected from trackball of another embodiment.

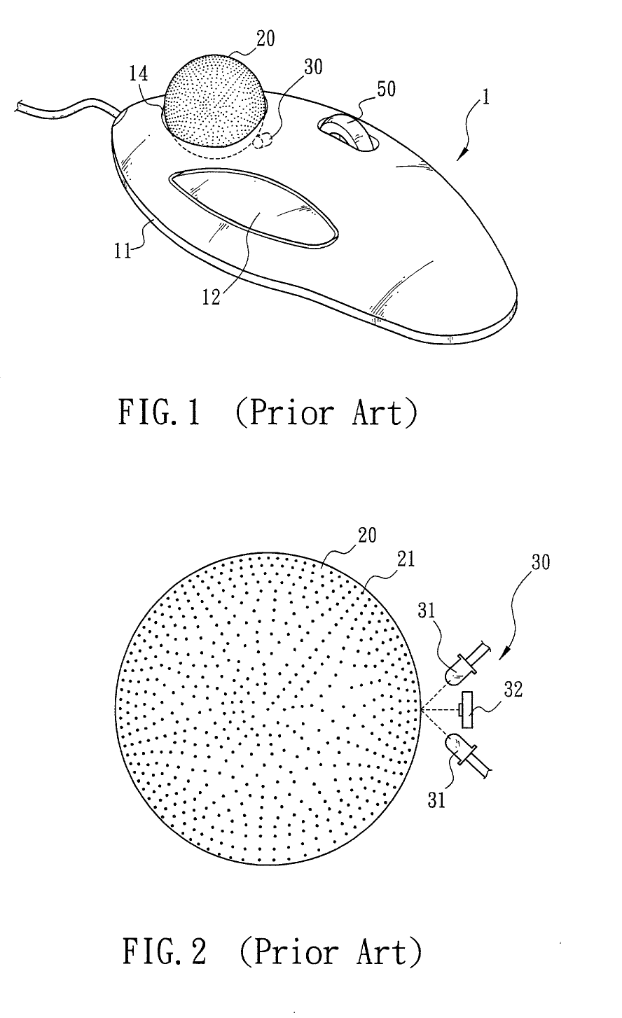

### DETAILED DESCRIPTION OF THE PREFERRED EMBODIMENTS

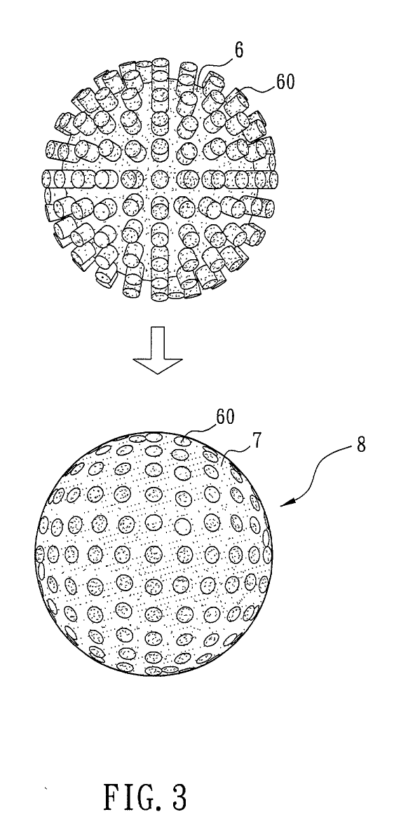

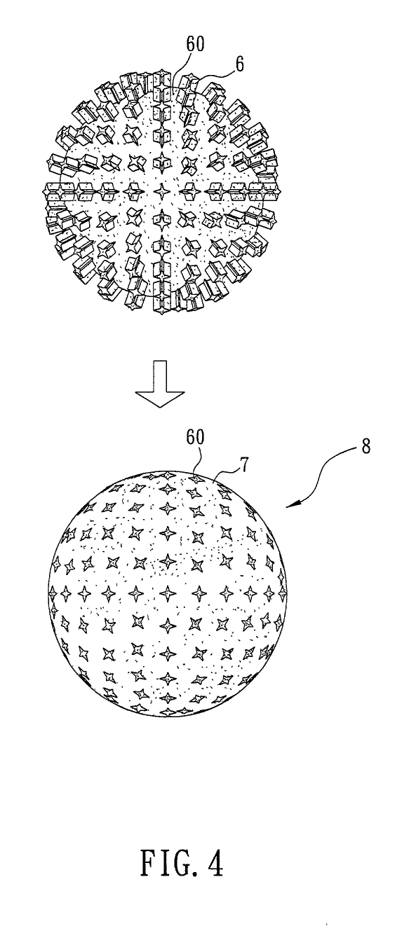

Referring to FIGS. 3 and 4, there are shown two embodiments of trackball 8 constructed in accordance with the invention each comprising a core layer 6 of a first color having an engagement section 60 on the surface including a plurality of equally spaced and uniformly distributed stubs having a cross-section of either cylinder (FIG. 3) or star (FIG. 4); and an outer layer 7 of a second color filled in the space between stubs with only a plurality of speckles formed on the surface. Thus formed trackball 8 has different colors.

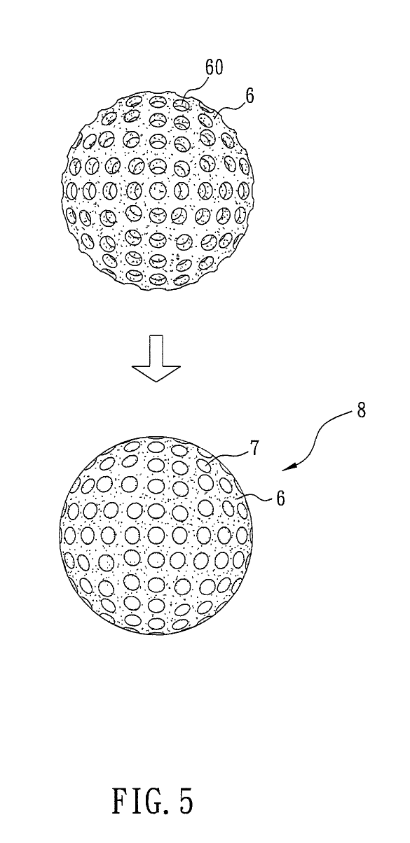

Referring to FIG. 5, there is shown a third preferred embodiment of trackball in which engagement section 60 formed on core layer 6 of a first color comprises a plurality of equally spaced and uniformly distributed dents and outer layer 7 of a second color is filled in dents. Hence, the top surface of each dent (i.e., the surface of outer layer 7) is flush with core layer 6. This forms a plurality of speckles (i.e., outer layer 7) on the surface of trackball 8. Further, thus formed trackball 8 has different colors.

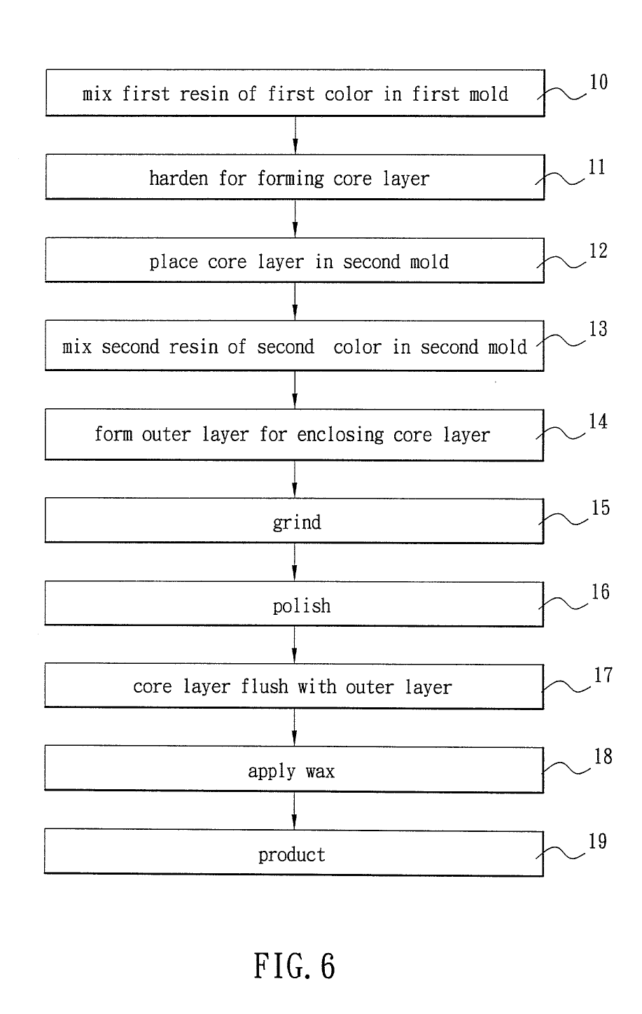

Referring to FIG. 6, there is shown a flow chart illustrating a trackball manufacturing process in accordance with the invention comprising the steps of 10) mixing a first resin of a first color with a hardening agent prior to pouring the mixture into a first mold; 11) hardening the mixture in the first mold to form a ball-shaped core layer having an engagement section 60 including a plurality of equally spaced and uniformly distributed stubs or dents; 12) place the core layer in a second mold; 13) mixing a second resin of a second color with the hardening agent prior to pouring the mixture into the second mold; 14) forming a ball-shaped outer layer in the second mold with the core layer enclosed therein; 15) grinding a surface of the outer layer; 16) polishing the outer layer; 17) making the core layer to be flush with the outer layer; 18) applying a wax on the outer layer and the core layer; and 19) forming a polished trackball of different colors with a plurality of equally spaced and uniformly distributed speckles.

In one embodiment, each of core layer 6 and outer layer 7 is formed of opaque resin. Further, both core layer 6 and outer layer 7 are capable of being hardened. Furthermore, the formed trackball has the advantages of smooth surface, not subject to deformation, low friction, and high manoeuverablilty.

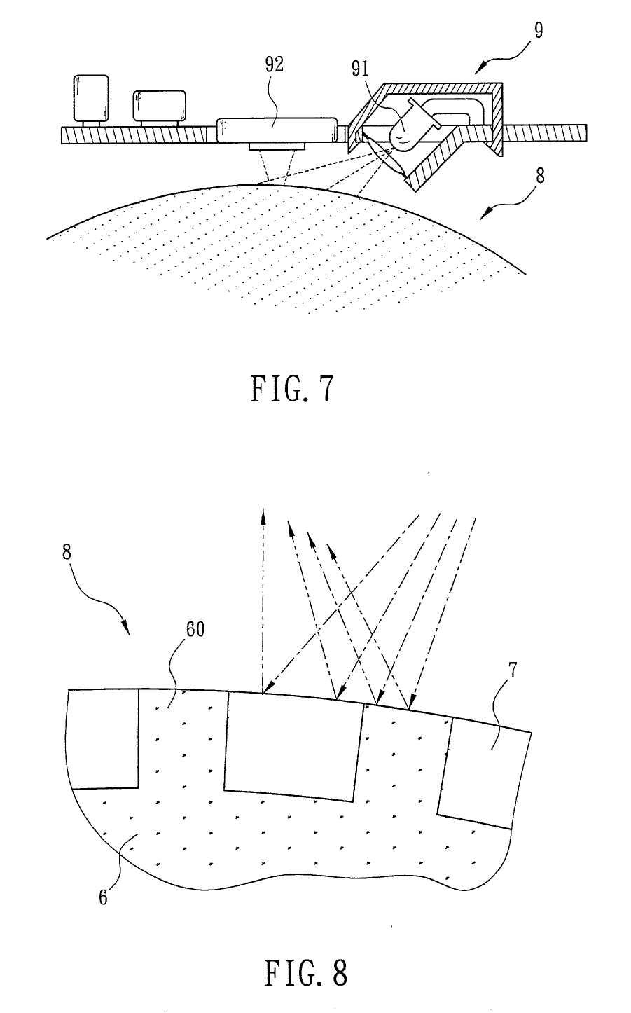

Referring to FIGS. 7 and 8, trackball 8 is rotatably mounted in a hole of a cursor pointing device. An optical device 9 is disposed adjacent trackball 8. A light source 91 of optical device 9 is activated to impinge light on speckles on the surface of trackball 8 for creating an output. A photodetector element 92 of optical device 9 is activated to continuously sense image reflected from the surface of trackball 8 so as to correctly calculate a distance and direction of the movement of trackball 8. The provision of speckles can eliminate a diffusion of light from the surface of trackball as experienced on a smooth surface of another type of trackball. Such undesired diffusion of light can inhibit a correct sensing of image by the photodetector element 92. Hence, the invention can significantly reduce the manufacturing cost.

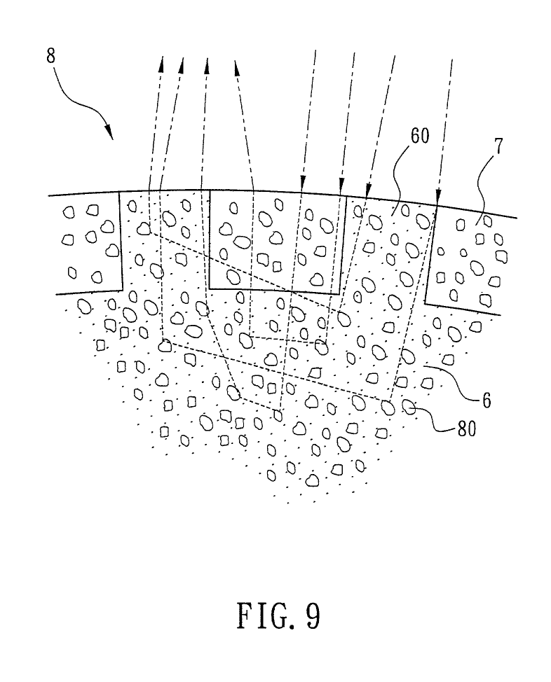

Referring to FIG. 9, there is shown another embodiment of trackball. Each of core layer 6 and outer layer 7 is formed of transparent or semi-transparent resin with reflective speckles (or particles) 80 randomly distributed therein. Referring to FIGS. 7 and 9, light source 91 is activated to emit light and cause most of it to penetrate into trackball 8 wherein a portion of the light is reflected back to the surface of trackball 8 by the speckles (or particles) 80 prior to further reflecting back. Hence, photodetector element 92 may continuously sense image reflected from the surface of trackball 8 so as to correctly calculate a distance and direction of the movement of trackball 8. The provision of speckles (or particles) 80 can eliminate a diffusion of light from the surface of trackball as experienced on a smooth surface of trackball. Such undesired diffusion of light can inhibit a correct sensing of image by the photodetector element 92.

In brief, light source 91 is activated to continuously sense image reflected from the surface of the moving trackball 8 so that photodetector element can obtain a correct image. Further, different colors are shown on trackball as light is impinged thereon by light source. This trackball is colorful. As to the speckles or particles, they are formed of pigment, mica powder, or pearl powder.

While the invention has been described by means of specific embodiments, numerous modifications and variations could be made thereto by those skilled in the art without departing from the scope and spirit of the invention set forth in the claims.

What is claimed is:

1. A trackball rotatably mounted in a hole of a cursor pointing device, comprising:
a core layer of a first color having an engagement section including a plurality of engagement members on a surface; and
an outer layer of a second color filled in a space between the engagement members
wherein a surface of the outer layer is flush with that of the core layer so that a plurality of speckles are formed on the engagement members and the trackball thus has two different colors.

2. The trackball of claim 1, wherein the engagement members are equally spaced and uniformly distributed stubs and the outer layer is filled in a space between the stubs so that the surface of the outer layer is flush with that of the core layer.

3. The trackball of claim 1, wherein the engagement members are equally spaced and uniformly distributed dents and the outer layer is filled in the dents so that the surface of the outer layer is flush with that of the core layer.

4. The trackball of claim 1, wherein each of the core and the outer layers is formed of an opaque resin.

5. The trackball of claim 1, wherein each of the core and the outer layers is formed of a transparent or semi-transparent resin.

6. The trackball of claim 1, wherein each of the core and the outer layers is formed of a transparent or semi-transparent material with a plurality of reflective speckles randomly distributed therein.

7. The trackball of claim 1, wherein each of the core and the outer layers is formed of a transparent or semi-transparent material with a plurality of reflective particles randomly distributed therein.
